(19) United States
(12) Patent Application Publication
(10) Pub. No.: US 2024/0430769 A1
(43) Pub. Date: Dec. 26, 2024

(54) WIRELESS COMMUNICATION DEVICE AND WIRELESS COMMUNICATION METHOD

(71) Applicant: JVCKENWOOD Corporation, Yokohama-shi (JP)

(72) Inventor: Wataru Shirai, Yokohama-shi (JP)

(21) Appl. No.: 18/826,258

(22) Filed: Sep. 6, 2024

Related U.S. Application Data
(63) Continuation of application No. PCT/JP2023/004595, filed on Feb. 10, 2023.

(30) Foreign Application Priority Data
Mar. 23, 2022 (JP) 2022-047517

(51) Int. Cl. H04W 36/30; H04B 17/318

(52) U.S. Cl. CPC H04W 36/30; H04B 17/318

(57) ABSTRACT

A wireless communication system, when a first mode is set, searches for a base station to be newly connected when a received radio field strength value falls below a first threshold, and changes the base station to be connected from a first base station to a second base station when information on the second base station, the information being received at a received radio field strength equal to or larger than a second threshold that is larger than a first threshold, is received from another wireless communication device, and when a second mode is set, searches for the base station to be newly connected when the received radio field strength value falls below a third threshold that is equal to or larger than the second threshold, and adopts the searched base station as the second base station and transmits information on the second base station.

### CROSS-REFERENCE TO RELATED APPLICATIONS

This application is a Continuation of PCT International Application No. PCT/JP2023/004595 filed on Feb. 10, 2023 which claims the benefit of priority from Japanese Patent Application No. 2022-047517 filed on Mar. 23, 2022, the entire contents of both of which are incorporated herein by reference.

### FIELD OF THE INVENTION

The present application relates to a wireless communication device and a wireless communication method.

### BACKGROUND OF THE INVENTION

A technology for controlling a connection between a wireless communication device and a base station is known. For example, Japanese Laid-open Patent Publication No. 2010-245813 describes a technology for reducing a search time of the base station.

A wireless communication device cancels, when communication quality falls below a predetermined value, communication with a current base station and searches for another base station with better communication quality. However, a weak electric field area in which communication quality of all base stations falls below the predetermined value is present, and, in this area, the wireless communication device enters an out-of-service state to cancel communication with the base station. The wireless communication device is able to reduce possibility to enter the out-of-service state by lowering a threshold for the communication quality that is a predetermined value at which the search is to be started. However, when the threshold is lowered, a search for a base station with better communication quality is not performed, and the communication quality may be deteriorated.

### SUMMARY OF THE INVENTION

A wireless communication device and a wireless communication method are disclosed.

According to one aspect of the present application, there is provided a wireless communication device comprising: a first communication unit configured to communicate with a base station by a first wireless communication system; a second communication unit configured to communicate with another wireless communication device by a second wireless communication system; a radio field strength measurement unit configured to measure a received radio field strength value of a radio wave that is received by the first communication unit from a first base station; a base station search unit configured to control the first communication unit to search for a base station to be newly connected based on the received radio field strength value that is measured by the radio field strength measurement unit; a communication controller configured to control the first communication unit and the second communication unit; and a mode setting unit configured to selectively set one of a first mode and a second mode that is different from the first mode, wherein when the mode setting unit sets the first mode, the base station search unit is further configured to search for the base station to be newly connected when the received radio field strength value that is measured by the radio field strength measurement unit falls below a first threshold that is set in advance, and the communication controller is further configured to change the base station to be connected from the first base station to a second base station when information on the second base station, the information being received at the received radio field strength equal to or larger than a second threshold that is set in advance and that is larger than the first threshold, is received from the another wireless communication device via the second communication unit, and when the mode setting unit sets the second mode, the base station search unit is further configured to search for the base station to be newly connected when the received radio field strength value that is measured by the radio field strength measurement unit falls below a third threshold that is set in advance and that is equal to or larger than the second threshold, and the communication controller is further configured to adopt the base station that is found by the base station search unit as the second base station to cause the second communication unit to transmit information on the second base station.

According to one aspect of the present application, there is provided a A wireless communication method comprising: communicating, by a first communication unit, with a base station by a first wireless communication system; communicating, by a second communication unit, with another wireless communication device by a second wireless communication system; measuring a received radio field strength value of a radio wave that is received from a first base station; searching for, by controlling the first communication unit, a base station to be newly connected based on the received radio field strength value that is measured at the measuring; controlling the first communication unit and the second communication unit; selectively setting one of a first mode and a second mode that is different from the first mode, wherein when the first mode is set, the searching further includes searching for the base station to be newly connected when the received radio field strength value that is measured at the measuring falls below a first threshold that is set in advance, and the controlling further includes changing the base station to be connected from the first base station to a second base station when information on the second base station, the information being received at the received radio field strength equal to or larger than a second threshold that is set in advance and that is larger than the first threshold, is received from the another wireless communication device via the second communication unit, and when the second mode is set, the searching further includes searching for the base station to be newly connected when the received radio field strength value that is measured at the measuring falls below a third threshold that is set in advance and that is equal to or larger than the second threshold, and the controlling further includes adopting the base station found by the searching as the second base station and transmitting information on the second base station by the second communication unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating a configuration example of a wireless communication system according to a first embodiment;

FIG. 2 is a block diagram illustrating a configuration example of a wireless communication device according to the first embodiment;

FIG. 3 is a sequence diagram illustrating a flow of a processes performed by the wireless communication system according to one embodiment;

FIG. 4 is a diagram for explaining a method of changing a threshold for an RSSI value from a reference threshold to a first threshold according to one embodiment;

FIG. 5 is a diagram for explaining a method of setting a second threshold for the RSSI value according to one embodiment;

FIG. 6 is a diagram for explaining a method of setting a third threshold for the RSSI value according to one embodiment;

FIG. 7 is a flowchart illustrating a flow of processes performed by the wireless communication device according to one embodiment; and

FIG. 8 is a flowchart illustrating a flow of processes performed by the wireless communication device according to one embodiment.

### DETAILED DESCRIPTION OF THE INVENTION

Embodiments according to the present application will be described in detail below with reference to the accompanying drawings. The present application is not limited by the embodiments below, and in the embodiments below, the same components are denoted by the same reference symbols and repeated explanation thereof will be omitted.

### First Embodiment

### Wireless Communication System

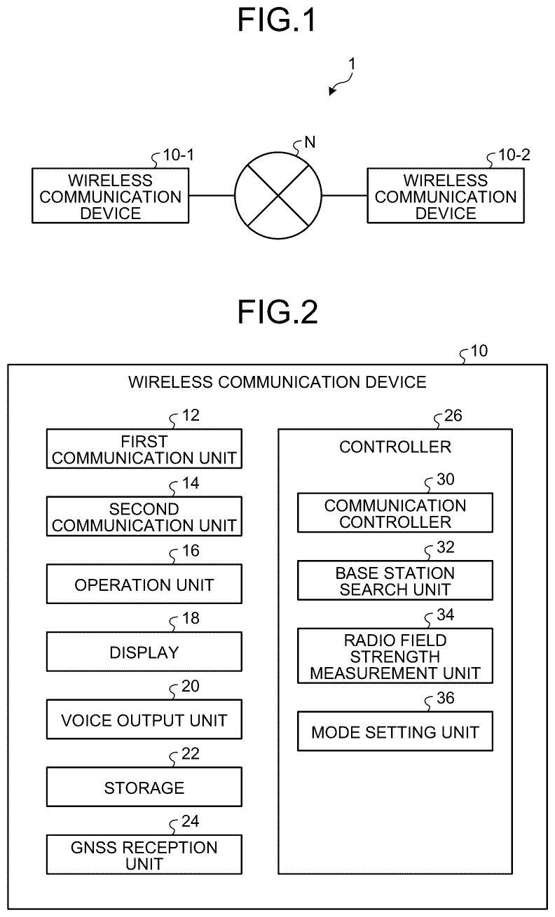

A configuration example of a wireless communication system according to a first embodiment will be described below with reference to FIG. 1. FIG. 1 is a diagram illustrating a configuration example of the wireless communication system according to the first embodiment.

As illustrated in FIG. 1, a wireless communication system 1 includes a wireless communication device 10-1 and a wireless communication device 10-2. The wireless communication device 10-1 and the wireless communication device 10-2 are communicably connected to each other via a network N. The wireless communication device 10-1 and the wireless communication device 10-2 may collectively be referred to as a wireless communication device 10 when they need not be distinguished from each other.

The wireless communication device 10-1 is connected to a first base station. The wireless communication device 10-2 is connected to a second base station including the first base station. The wireless communication device 10-1 is configured to change a base station to be connected from the first base station to the second base station based on first received radio field strength information, which includes information on the first base station and a first received radio field strength of a radio wave that is received from the first base station, and based on second received radio field strength information, which includes information on the second base station received from the wireless communication device 10-2 and a second received radio field strength of a radio wave that is received from the second base station. Examples of the information on the base station include information on a frequency and an identifier used by the base station.

The wireless communication device 10-1 and the wireless communication device 10-2 are, for example, wireless communication devices for business use, but embodiments are not limited to this example. One of the wireless communication device 10-1 and the wireless communication device 10-2 may be an on-vehicle wireless communication device, and the other one may be a wireless communication device of a handy type. The wireless communication device 10-1 and the wireless communication device 10-2 may be carried by an identical user, or may be carried by different users. It is preferable to arrange the wireless communication device 10-1 and the wireless communication device 10-2 adjacent to each other and adopt the same environment for measuring received radio field strength values of radio waves that are received from the base stations.

### Wireless Communication Device

The wireless communication device according to the first embodiment will be described below with reference to FIG. 2. FIG. 2 is a block diagram illustrating a configuration example of the wireless communication device according to the first embodiment.

As illustrated in FIG. 2, the wireless communication device 10 includes a first communication unit 12, a second communication unit 14, an operation unit 16, a display 18, a voice output unit 20, a storage 22, a Global Navigation Satellite System (GNSS) reception unit 24, and a controller 26.

The first communication unit 12 communicates with a base station by a long-distance wireless communication system. The long-distance wireless communication system is a kind of a first wireless communication system. Examples of the long-distance wireless communication system include a digital business radio, such as Association of Public safety Communications Officials international Project 25 (APCO-P25) and NXDN (registered trademark). The long-distance wireless communication system may be communication using a mobile phone network.

The second communication unit 14 communicates with another wireless communication device 10 by a near field communication system. The near field communication system is a kind of a second wireless communication system. The network N illustrated in FIG. 1 is, for example, communicably connected between the second communication unit 14 of the wireless communication device 10-1 and the second communication unit 14 of the wireless communication device 10-2. Examples of the near field communication system include communication using Wi-Fi (registered trademark) and Bluetooth (registered trademark), but embodiments are not limited to these examples. The second communication unit 14 may perform communication in a wired manner.

The operation unit 16 receives various kinds of input operation on the wireless communication device 10. The operation unit 16 outputs an operation signal corresponding to the received input operation to the controller 26. Examples of the operation unit 16 include a touch panel, a button, a switch, and a microphone. When a touch panel is used as the operation unit 16, the operation unit 16 is arranged on the display 18.

The display 8 displays various kinds of videos. The display unit 18 is, for example, a display including a Liquid Crystal Display (LCD), organic Electro-Luminescence (EL), or the like.

The voice output unit 20 is a speaker that outputs various kinds of voices. For example, the voice output unit 20 outputs a voice of a caller.

The storage 22 stores therein various kinds of information. The storage 22 stores therein information such as calculation details of the controller 26 and a program. The storage 22 includes, for example, at least one of a main storage device such as a Random Access Memory (RAM) or a Read Only Memory (ROM), and an external storage device such as a Hard Disk Drive (HDD).

The GNSS reception unit 24 is configured with a GNSS receiver or the like that receives GNSS signals from GNSS satellites. The GNSS reception unit 24 outputs a received GNSS signals to the controller 26.

The controller 26 controls each of the units of the wireless communication device 10. The controller 26 includes, for example, an information processing device, such as a Central Processing Unit (CPU) or a Micro Processing Unit (MPU), and a storage device, such as a RAM or a ROM. The controller 26 executes a program that controls operation of the wireless communication device 10 according to the present application. The controller 26 may be implemented by, for example, an integrated circuit such as an Application Specific Integrated Circuit (ASIC) or a Field Programmable Gate Array (FPGA). The controller 26 may be implemented by a combination of hardware and software.

The controller 26 includes a communication controller 30, a base station search unit 32, a radio field strength measurement unit 34, and a mode setting unit 36.

The communication controller 30 controls the first communication unit 12 and the second communication unit 14. The communication controller 30 causes the first communication unit 12 to perform communication with a base station. The communication controller 30 controls the first communication unit 12 to change a base station that performs communication with the wireless communication device 10. The communication controller 30 controls the second communication unit 14 to perform communication with another wireless communication device 10.

The base station search unit 32 searches for a base station that performs communication with the wireless communication device 10. The base station search unit 32 searches for a base station that performs communication with the wireless communication device 10 via the first communication unit 12.

The radio field strength measurement unit 34 measures a received radio field strength related to a radio wave that is received by the first communication unit 12 from the base station. The radio field strength measurement unit 34 measures, for example, a Received Signal Strength Indicator (RSSI) value of a radio wave that is received by the first communication unit 12 from the base station.

The mode setting unit 36 sets an operation mode of the wireless communication device 10 for changing a base station to be connected in cooperation with the wireless communication devices 10. A first mode that is set by the mode setting unit 36 is a mode in which the station to be connected is changed based on a received radio field strength of a radio wave that is received from a base station to which the own wireless communication device 10 is connected and based on a received radio field strength of another base station that is included in the received radio field strength information that is provided from another wireless communication device 10. A second mode that is set by the mode setting unit 36 is a mode in which received radio field strength information of a base station that is searched for by the own wireless communication device 10 is provided to the wireless communication device 10 that is set to the first mode. The mode setting unit 36 selectively sets one of the first mode and the second mode for the wireless communication device 10.

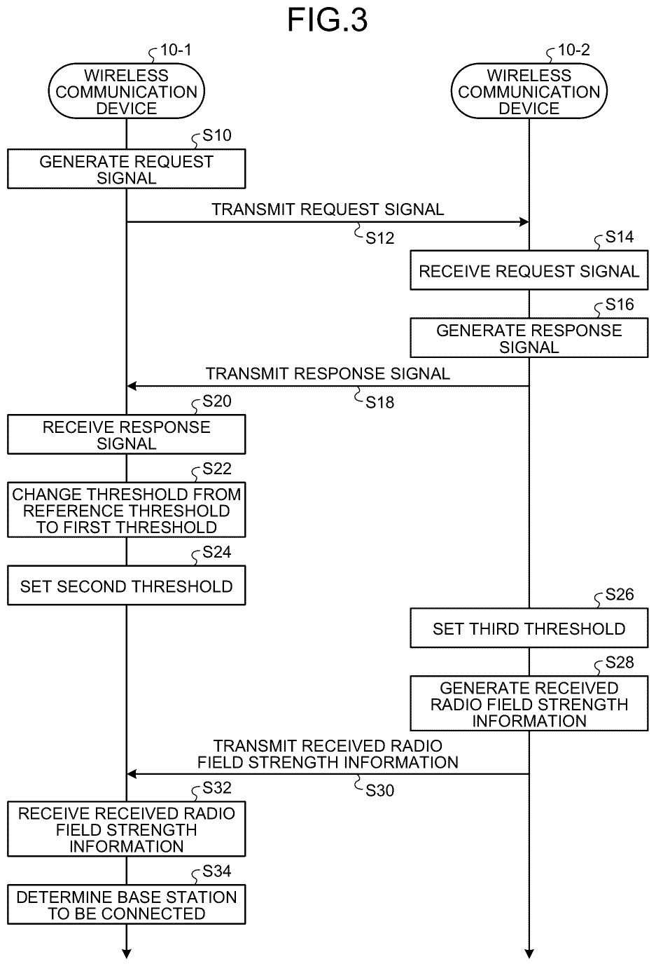

Process performed by wireless communication system Details of processes performed by the wireless communication system according to one embodiment will be described below with reference to FIG. 3. FIG. 3 is a sequence diagram illustrating a flow of processes performed by the wireless communication system according to one embodiment.

FIG. 3 illustrates an example of a flow of processes that is performed between the wireless communication device 10-1 and the wireless communication device 10-2. In the example illustrated in FIG. 3, the wireless communication device 10-1 is set to the first mode by the mode setting unit 36. It is assumed that the wireless communication device 10-1 is the wireless communication device 10 that performs voice communication and data communication with a base station, and is a wireless communication device that uses the received radio field strength information that is provided by the wireless communication device 10-2 in a process of changing a base station to be connected. Further, the wireless communication device 10-2 is set to the second mode by the mode setting unit 36. In this case, the wireless communication device 10-2 provides the received radio field strength information on a base station that is searched for by the wireless communication device 10-2 to the wireless communication device 10-1 in order to change the base station that communicates with the wireless communication device 10-1. FIG. 3 illustrates processes performed until the wireless communication device 10-1 determines a base station that serves as a connection destination.

The wireless communication device 10-1, in order to change a base station to be connected, generates a request signal for pairing for establishing a connection with the network N in FIG. 1 for performing communication with the wireless communication device 10-2 (Step S10). The request signal includes a signal for requesting paring such that the received radio field strength information is to be provided to change the base station to be connected. Then, the process proceeds to Step S12.

The wireless communication device 10-1 transmits the generated request signal to the wireless communication device 10-2 (Step S12). Then, the process proceeds to Step S14.

The wireless communication device 10-2 receives the request signal from the wireless communication device 10-1 (Step S14). Then, the process proceeds to Step S16.

The wireless communication device 10-2 generates a response signal in response to the request signal (Step S16). The wireless communication device 10-2 generates a response signal that indicates permission of the pairing when permitting the request for the pairing with the wireless communication device 10-1. The wireless communication device 10-2 generates a response signal that indicates refusal of the pairing when refusing the pairing with the wireless communication device 10-2. In the example illustrated in FIG. 3, it is assumed that the wireless communication device 10-2 generates the response signal that indicates permission of the paring. Then, the process proceeds to Step S18.

The wireless communication device 10-2 transmits the generated response signal to the wireless communication device 10-1 (Step S18). Then, the process proceeds to Step S20.

The wireless communication device 10-1 receives the response signal from the wireless communication device 10-2 (Step S20). When the wireless communication device 10-1 receives the response signal that indicates permission of the paring from the wireless communication device 10-2 the paring is completed. Then, the process proceeds to Step S22.

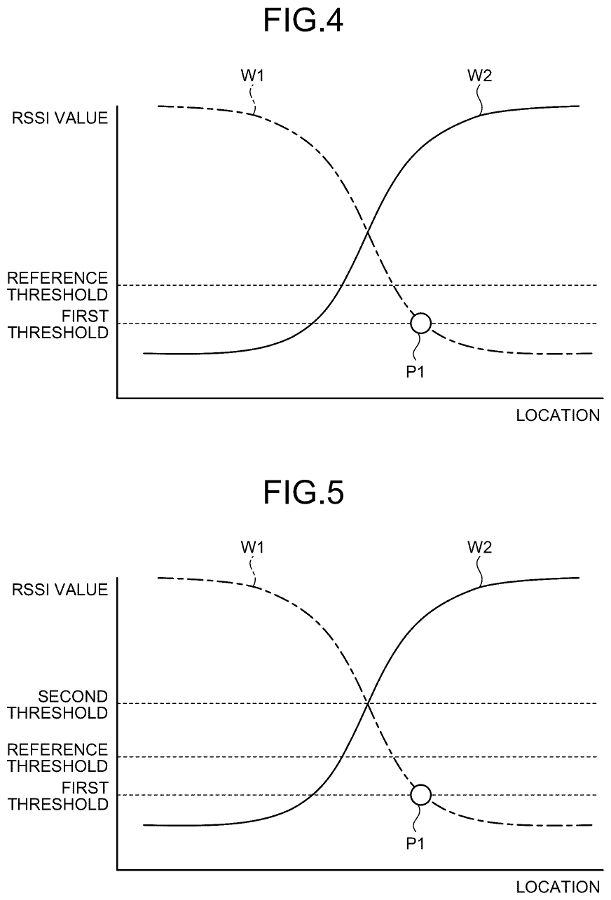

The wireless communication device 10-1 changes a threshold for an RSSI value, by which it is determined that a base station is to be searched for, from a reference threshold to a first threshold (Step S22). FIG. 4 is a diagram for explaining a method of changing the threshold for the RSSI value from the reference threshold to the first threshold according to one embodiment. In FIG. 4, a horizontal axis represents a location, and a vertical axis represents the RSSI value. A waveform W1 represents an RSSI value of the first base station that is communicating with the wireless communication device 10-1. A waveform W2 represents an RSSI value of the second base station that is different from the first base station. A point P1 represents the RSSI value of the first base station at a current location of the wireless communication device 10-1. The reference threshold represents a threshold of the RSSI value as a reference value that is used as a trigger to start to search for a base station at a normal state in which the wireless communication device 10-1 is not connected to the wireless communication device 10-2. At a normal state, the wireless communication device 10-1 determines that it is needed to search for a base station to be newly connected when the RSSI value falls below the reference threshold. When the wireless communication device 10-1 completes the pairing with the wireless communication device 10-2, the wireless communication device 10-1 changes the reference value of the RSSI value from the reference threshold to the first threshold. In other words, the wireless communication device 10-1 prevents the base station to be connected from being easily changed. Accordingly, the wireless communication device 10-1 continuously connects to the first base station even if the RSSI value of the first base station falls below the reference value. This is done to maintain the connection to the current base station even when the communication quality is deteriorated since it is not always possible to find a better base station even if another base station is searched for immediately after the wireless communication device 10-1 falls below the reference threshold. Then, the process proceeds to Step S24.

The wireless communication device 10-1 sets a second threshold (Step S24). FIG. 5 is a diagram for explaining a method of setting the second threshold for the RSSI value according to one embodiment. In FIG. 5, a horizontal axis represents a location, and a vertical axis represents the RSSI value. As illustrated in FIG. 5, the wireless communication device 10-1 sets the second threshold that is larger than the first threshold. The second threshold is set to a value that is larger than the first threshold and larger than the reference threshold. The wireless communication device 10-1 determines that the connection is changed from the first base station to the second base station when the second received radio field strength of the second base station that is received from the wireless communication device 10-2 is equal to or larger than the second threshold, and is larger than the received radio field strength of the first base station that is connected to the wireless communication device 10-1. Since the wireless communication device 10-1 is able to change the connection to another base station at an earlier timing when another base station that has a larger received radio field strength is present, and thereby maintain good communication quality. Then, the process proceeds to Step S26.

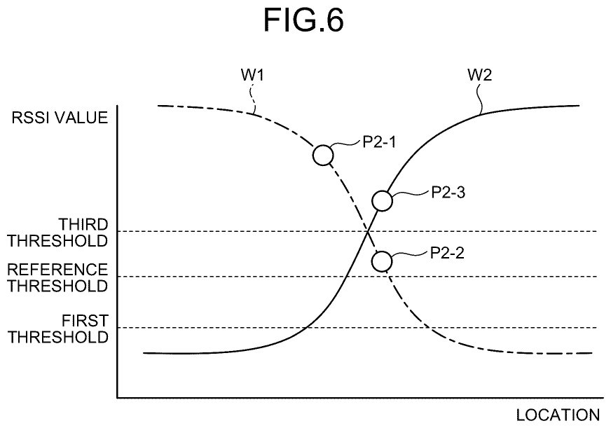

The wireless communication device 10-2 sets a third threshold (Step S26). FIG. 6 is a diagram for explaining a method of setting the third threshold for the RSSI value according to one embodiment. In FIG. 6, a horizontal axis represents a location, and a vertical axis represents the RSSI value. A point P2-1 and a point P2-2 represent the RSSI values of the first base station at corresponding locations of the wireless communication device 10-2. A point P2-3 represents the RSSI value of the second base station at a corresponding location of the wireless communication device 10-2. As illustrated in FIG. 6, the wireless communication device 10-2 sets the third threshold that is larger than the first threshold. The third threshold is set to a value that is larger than the reference threshold and equal to or larger than the second threshold. The wireless communication device 10-2 searches for another base station and changes the connection to another base station with a larger RSSI value when the RSSI value of the currently connected base station falls below the third threshold. In the example illustrated in FIG. 6, the wireless communication device 10-2 is firstly connected to the first base station and receives a signal of the RSSI value of the waveform W1 at the location of the point P2-1. Subsequently, the wireless communication device 10-2 moves to the location of the point P2-2, and if the RSSI value of the signal being received from the first base station attenuates as indicated by the waveform W1 and falls below the third threshold, the wireless communication device 10-2 searches for another base station with a larger RSSI value. As a result, a base station 2 with a larger RSSI value as indicated by the waveform W2 is found. Then, the wireless communication device 10-2 receives a signal of the RSSI value of the waveform W2 at the location of the point P2-3. The wireless communication device 10-2 transmits, as the second received radio field strength, information on the found second base station and the RSSI value of the second base station at the point P2-3 to the wireless communication device 10-1. Accordingly, the wireless communication device 10-1 is able to easily change the connection to the base station with the larger RSSI value. Then, the process proceeds to Step S28.

The wireless communication device 10-2 generates the received radio field strength information (Step S28). The wireless communication device 10-2 generates the received radio field strength information in which information on the base station that has transmitted a radio wave is associated with the RSSI value of the radio wave received from the base station. Then, the process proceeds to Step S30.

The wireless communication device 10-2 transmits the generated received radio field strength information to the wireless communication device 10-1 (Step S30). Then, the process proceeds to Step S32.

The wireless communication device 10-1 receives the received radio field strength information from the wireless communication device 10-2 (Step S32). Then, the process proceeds to Step S34.

The wireless communication device 10-1 determines a base station to be connected based on the received radio field strength received by the own device from the base station, the received radio field strength that is included in the received radio field strength information received from the wireless communication device 10-2, the first threshold, and the second threshold (Step S34). Then, the process in FIG. 3 is terminated.

### Process Performed by Wireless Communication Device

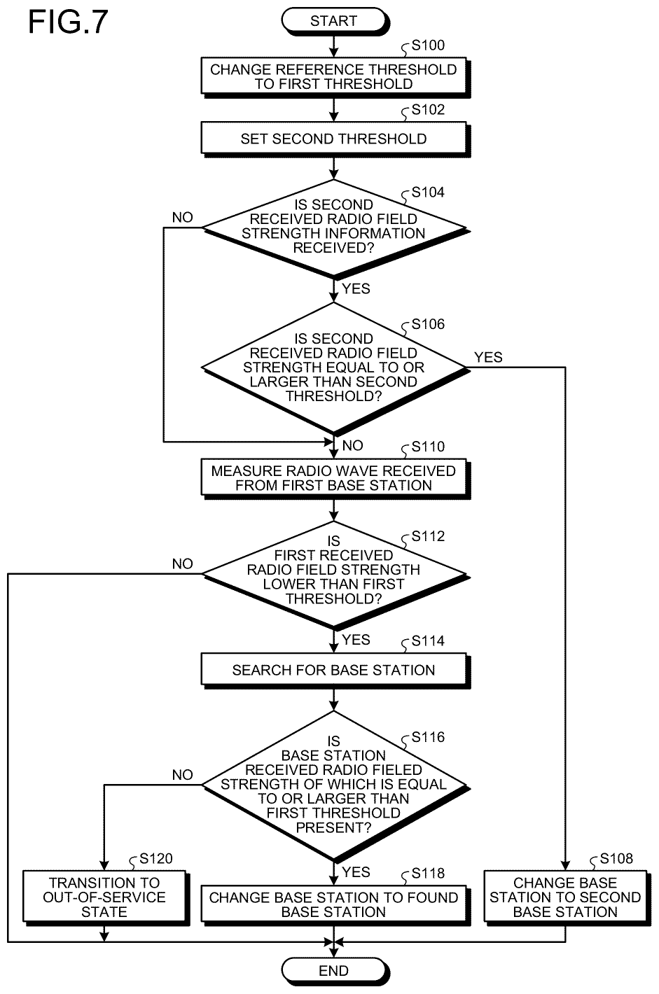

Details of a process performed by the wireless communication device according to one embodiment will be described below with reference to FIG. 7. FIG. 7 is a flowchart illustrating a flow of processes performed by the wireless communication device according to one embodiment.

FIG. 7 illustrates a flow of processes performed by the wireless communication device 10 that is set to the first mode in which a connection to the base station is to be changed. For example, at the starting point of the process illustrated in FIG. 7, the wireless communication device 10 that is set to the first mode and another wireless communication device 10 that is set to the second mode connect to the same first base station. For example, another wireless communication device 10 that is set to the second mode may connect to the second base station that is different from the first base station.

The communication controller 30 changes the threshold for the RSSI value for searching for a base station to be connected from the reference threshold to the first threshold that is lower than the reference threshold based on the first received radio field strength information (Step S100). A user of the wireless communication device 10 is able to set the first threshold to an arbitrary value via the operation unit 16. Then, the process proceeds to Step S102.

The communication controller 30 sets the second threshold that is larger than the first threshold as the RSSI value for determining whether or not to change the base station to be connected, based on the second received radio field strength information (Step S102). The user of the wireless communication device 10 is able to set the second threshold to an arbitrary value via the operation unit 16. Then, the process proceeds to Step S104.

The communication controller 30 determines whether or not the second received radio field strength information is received from another wireless communication device that is set to the second mode via the second communication unit 14 (Step S104). When it is determined that the second received radio field strength information is received (Step S104; Yes), the process proceeds to Step S106. When it is not determined that the second received radio field strength information is received (Step S104; No), the process proceeds to Step S110.

When it is determined as Yes at Step S104, the radio field strength measurement unit 34 determines whether or not the second received radio field strength that is included in the second received radio field strength information is equal to or larger than the second threshold (Step S106). When it is determined that the second received radio field strength is equal to or larger than the second threshold (Step S106; Yes), the process proceeds to Step S108. When it is not determined that the second received radio field strength is equal to or larger than the second threshold (Step S106; No), the process proceeds to Step S110.

When it is determined as Yes at Step S106, the communication controller 30 changes the base station that is connected to the wireless communication device 10 from the first base station to the second base station based on the information on the base station included in the second received radio field strength information (Step S108). In other words, the wireless communication device 10 that is set to the first mode and another wireless communication device 10 that is set to the second mode connect to the same second base station. Then, the process in FIG. 7 is terminated.

When it is determined as No at Step S104, or when it is determined as No at Step S106, the radio field strength measurement unit 34 measures a radio wave received from the first base station (Step S110). Specifically, the radio field strength measurement unit 34 measures the first received radio field strength of a radio wave that the first communication unit 12 is receiving from the first base station to which the wireless communication device 10 is currently connected. Then, the process proceeds to Step S112.

The radio field strength measurement unit 34 determines whether or not the first received radio field strength is lower than the first threshold (Step S112). When it is determined that the first received radio field strength is lower than the first threshold (Step S112; Yes), the process proceeds to Step S114. When it is not determined that the first received radio field strength is lower than the first threshold (Step S112; No), the connected base station is not changed and the process in FIG. 7 is terminated.

When it is determined as Yes at Step S112, the base station search unit 32 searches for a base station to which the connection is changed from the first base station (Step S114). Then, the process proceeds to Step S116.

The radio field strength measurement unit 34 determines whether or not a base station the received radio field strength of which is equal to or larger than the first threshold is present (Step S116). When it is determined that the base station the received radio field strength of which is equal to or larger than the first threshold is present (Step S116; Yes), the process proceeds to Step S118. When it is not determined that the base station the received radio field strength of which is equal to or larger than the first threshold is present (Step S116; No), the process proceeds to Step S120.

When it is determined as Yes at Step S116, the communication controller 30 changes the base station that is connected to the wireless communication device 10 from the first base station to the base station which is searched for by the base station search unit 32 and the received radio field strength of which is equal to or larger than the first threshold (Step S118). When multiple base stations the received radio field strengths of which are equal to or larger than the first threshold are present, the communication controller 30 changes the connection from the first base station to a base station the received radio field strength of which has the largest value among the multiple base stations. Then, the process in FIG. 7 is terminated.

When it is determined as No at Step S116, the wireless communication device 10 transitions to the out-of-service state since a connectable base station is absent (Step S120). The wireless communication device 10 is not able to perform communication after transitioning to the out-of-service state. Then, the process in FIG. 7 is terminated. Meanwhile, although not illustrated in the drawings, the wireless communication device 10 that has entered the out-of-service state continuously searches for a base station, and when finding a base station from which the radio wave can be received at the received radio field strength equal to or larger than the first threshold, the processes in FIG. 7 start again.

### Process Performed by Wireless Communication Device

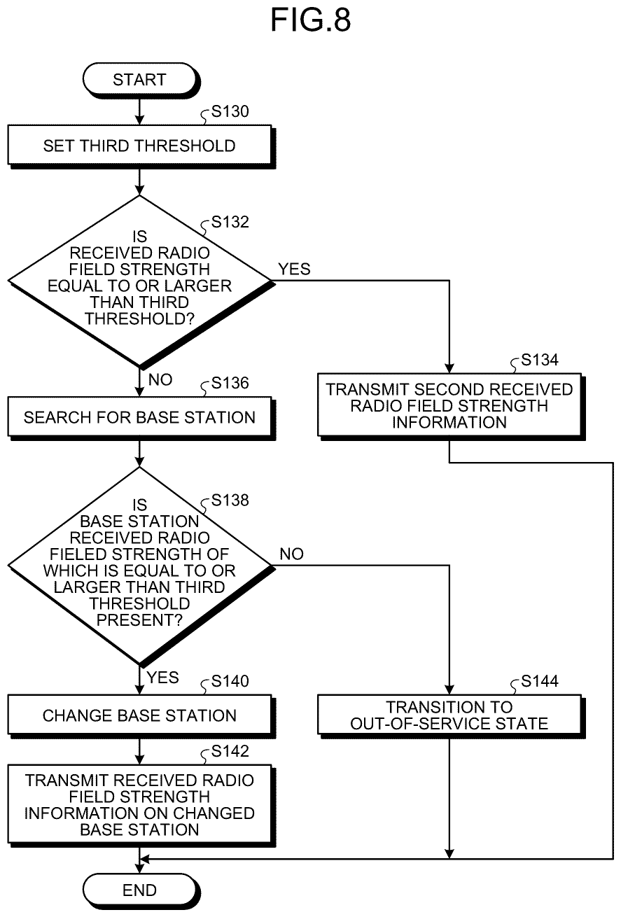

Details of a process performed by the wireless communication device according to one embodiment will be described below with reference to FIG. 8. FIG. 8 is a sequence diagram illustrating a flow of processes performed by the wireless communication device according to one embodiment.

FIG. 8 illustrates a flow of processes performed by the wireless communication device 10 that is set to the second mode for providing information to another wireless communication device 10 that is set to the first mode and that changes a connection to a base station.

The communication controller 30 sets the third threshold that is larger than the first threshold, as the RSSI value that is used as a reference for searching for a base station in order to provide the received radio field strength information to another wireless communication device 10 that is set to the first mode and that changes a base station to be connected (Step S130). The user of the wireless communication device 10 is able to set the third threshold to an arbitrary value via the operation unit 16. Then, the process proceeds to Step S132.

The radio field strength measurement unit 34 determines whether or not the received radio field strength of a radio wave from the currently connected base station is equal to or larger than the third threshold (Step S132). When it is determined that the received radio field strength is equal to or larger than the third threshold (Step S132; Yes), the process proceeds to Step S134. When it is not determined that the received radio field strength is equal to or larger than the third threshold (Step S132; No), the process proceeds to Step S136.

When it is determined as Yes at Step S132, the communication controller 30 adopts the currently connected base station as the second base station and transmits, as the second received radio field strength information, information on the second base station and the second received radio field strength that is the received radio field strength of the second base station to another wireless communication device 10 that is set to the first mode via the second communication unit 14 (Step S134). Then, the process in FIG. 8 is terminated.

When it is determined as No at Step S132, the base station search unit 32 searches for a base station changed to be connected (Step S136). Then, the process proceeds to Step S138.

The radio field strength measurement unit 34 determines whether or not the base station that is searched for at Step S136 includes a base station the received radio field strength of which is equal to or larger than the third threshold (Step S138). When it is determined that the base station the received radio field strength of which is equal to or larger than the third threshold is present (Step S138; Yes), the process proceeds to Step S140. When it is not determined that the base station the received radio field strength of which is equal to or larger than the third threshold is present (Step S138; No), the process proceeds to Step S144.

When it is determined as Yes at Step S138, the communication controller 30 changes the base station that is currently connected to the wireless communication device 10 to the base station which is searched for by the base station search unit 32 and the received radio field strength of which is equal to or larger than the third threshold (Step S140). Here, when multiple base stations the received radio field strengths of which are equal to or larger than the third threshold are present, the communication controller 30 changes the connection to a base station the received radio field strength of which has the largest value among the multiple base stations. Then, the process proceeds to Step S142.

The communication controller 30 adopts the base station that is changed at Step S140 as the second base station and transmits, as the second received radio field strength information, the information on the second base station and the second received radio field strength that is the received radio field strength of the second base station to another wireless communication device 10 that is set to the first mode via the second communication unit 14 (Step S142). Then, the process in FIG. 8 is terminated.

When it is determined as No at Step S138, the wireless communication device 10 transitions to the out-of-service state since a connectable base station is absent (Step S144). The wireless communication device 10 is not able to transmit the received radio field strength information of another wireless communication device after transitioning to the out-of-service state. Then, the process in FIG. 8 is terminated. Meanwhile, although not illustrated in the drawings, the wireless communication device 10 that has entered the out-of-service state continuously searches for a base station, and when finding a base station from which a radio wave can be received at a radio field strength equal to or larger than the third threshold, starts the processes in FIG. 8 again.

As described above, in the present embodiment, the wireless communication device that changes a connection to a base station changes the connection to a new base station with better communication quality without searching for base stations when information on a base station is provided from another wireless communication device at a received radio field strength equal to or larger than the second threshold that is larger than the normally used reference threshold, and, when information on a base station is not provided from another wireless communication device at a received radio field strength equal to or larger than the second threshold, the wireless communication device maintains the connection to the base station until the received radio field strength of the currently connected base station falls below the first threshold that is smaller than the normally used reference threshold. With this configuration, in the present embodiment, it is possible to ensure communication quality and reduce a possibility to enter an out-of-service state when a wireless communication device is used.

The components of the devices illustrated in the drawings are functionally conceptual, and need not be physically configured in the manner illustrated in the drawings. In other words, specific forms of distribution and integration of the devices are not limited to those illustrated in the drawings, and all or part of the devices may be functionally or physically distributed or integrated in arbitrary units depending on various loads or use conditions. Meanwhile, configurations made by the distribution and the integration as described above may be performed dynamically.

According to the present application, it is possible to ensure communication quality and reduce a possibility to enter an out-of-service state.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

The wireless communication device and the wireless communication method according to the present application can be used for a wireless communication device.

What is claimed is:

1. A wireless communication device comprising:
a first communication unit configured to communicate with a base station by a first wireless communication system;
a second communication unit configured to communicate with another wireless communication device by a second wireless communication system;
a radio field strength measurement unit configured to measure a received radio field strength value of a radio wave that is received by the first communication unit from a first base station;
a base station search unit configured to control the first communication unit to search for a base station to be newly connected based on the received radio field strength value that is measured by the radio field strength measurement unit;
a communication controller configured to control the first communication unit and the second communication unit; and
a mode setting unit configured to selectively set one of a first mode and a second mode that is different from the first mode, wherein
when the mode setting unit sets the first mode,
the base station search unit is further configured to search for the base station to be newly connected when the received radio field strength value that is measured by the radio field strength measurement unit falls below a first threshold that is set in advance, and
the communication controller is further configured to change the base station to be connected from the first base station to a second base station when information on the second base station, the information being received at the received radio field strength equal to or larger than a second threshold that is set in advance and that is larger than the first threshold, is received from the another wireless communication device via the second communication unit, and
when the mode setting unit sets the second mode,
the base station search unit is further configured to search for the base station to be newly connected when the received radio field strength value that is measured by the radio field strength measurement unit falls below a third threshold that is set in advance and that is equal to or larger than the second threshold, and
the communication controller is further configured to adopt the base station that is found by the base station search unit as the second base station to cause the second communication unit to transmit information on the second base station.

2. A wireless communication method comprising:
communicating, by a first communication unit, with a base station by a first wireless communication system;
communicating, by a second communication unit, with another wireless communication device by a second wireless communication system;
measuring a received radio field strength value of a radio wave that is received from a first base station;
searching for, by controlling the first communication unit, a base station to be newly connected based on the received radio field strength value that is measured at the measuring;
controlling the first communication unit and the second communication unit;
selectively setting one of a first mode and a second mode that is different from the first mode, wherein
when the first mode is set,
the searching further includes searching for the base station to be newly connected when the received radio field strength value that is measured at the measuring falls below a first threshold that is set in advance, and
the controlling further includes changing the base station to be connected from the first base station to a second base station when information on the second base station, the information being received at the received radio field strength equal to or larger than a second threshold that is set in advance and that is larger than the first threshold, is received from the another wireless communication device via the second communication unit, and
when the second mode is set,
the searching further includes searching for the base station to be newly connected when the received radio field strength value that is measured at the measuring falls below a third threshold that is set in advance and that is equal to or larger than the second threshold, and
the controlling further includes adopting the base station found by the searching as the second base station and transmitting information on the second base station by the second communication unit.
